(19) United States
(12) Patent Application Publication
(10) Pub. No.: US 2014/0015213 A1
(43) Pub. Date: Jan. 16, 2014

(54) TRACTOR HAVING REINFORCED BUFFERING FUNCTION

(71) Applicant: Joong-Ho Kim, Okcheon-gun (KR)

(72) Inventor: Joong-Ho Kim, Okcheon-gun (KR)

(21) Appl. No.: 14/005,793

(22) PCT Filed: Mar. 19, 2012
(86) PCT No.: PCT/KR2012/001957

§ 371 Date: Sep. 17, 2013

(30) Foreign Application Priority Data
Mar. 23, 2011 (KR) 10-2011-0025863

(51) Int. Cl. B60G 21/05; B60G 5/04

(52) U.S. Cl. CPC B60G 21/05; B60G 5/04
USPC 280/124.116

(57) ABSTRACT

Disclosed herein is a tractor having a reinforced buffering function. The tractor includes: an upper link (51) and a lower link (52) which are hinged to upper and lower portions of a front axle (50) to form four-bar link structures on the left and right portions of the front axle; buffer cylinders (53) installed on the left and right portions of the front axle to provide a buffering structure for absorbing shock applied to the front axle; a pair of arms (61) installed on left and right portions of a rear axle (60) such that the arms are movable with respect to only the vertical direction; and buffer cylinders (62) respectively provided on the left and right portions of the rear axle to provide a buffering structure for absorbing shock applied to the rear axle, thereby more effectively absorbing shock applied to the front and rear axles of the tractor.

### TECHNICAL FIELD

The present invention relates, in general, to tractors having reinforced buffering functions and, more particularly, to a tractor having a reinforced buffering function which includes: an upper link and a lower link which are hinged to upper and lower portions of a front axle so as to form a pair of four-bar link structures on the left and right portions of the front axle; buffer cylinders respectively installed on the left and right portions of the front axle to provide a buffering structure for absorbing vertical shock applied to the front axle; a pair of arms respectively installed on left and right portions of a rear axle and configured such that the arms are stationary with respect to the lateral direction and are movable with respect to the vertical direction; and buffer cylinders respectively provided on the left and right portions of the rear axle so as to provide a buffering structure for absorbing vertical shock applied to the rear axle, thereby more effectively absorbing shock applied to the front and rear axles of the tractor when the tractor carries out work or moves.

### BACKGROUND ART

Generally, a tractor is an engineering vehicle designed to deliver a high tractive force and conduct different kinds of work in the fields of agriculture or construction. At present, tractors used in agriculture typically include a front loader provided on a front end of a tractor body, and an attachment mounted to the front loader so as to conduct various kinds of work, such as transportation, unloading, loading, etc. Furthermore, a rotavator or the like is mounted to a rear end of the tractor body by a rear link so that work such as plowing can be conducted.

In such tractors used in agriculture, power generated from an engine is classified into movement-related power which is transmitted to wheels through a transmission to enable a tractor to move, and PTO (power take-off)-related power which is used to drive different kinds of operating implements mounted to the tractor. To embody transmission of the movement-related power, a four-wheel drive system is typically used.

The structures of such typical tractors are similar to those of general automobiles, but the tractors have much more powerful engines compared to those of general automobiles, and working conditions are rough, for example, the ground of a work place is uneven, there is the possibility of the tractors colliding with obstacles during work, etc. However, typical tractors do not have a satisfactory buffering structure.

As a result, drivers become easily tired even after a short time of work. In terms of the tractors, apparatuses and elements constituting the tractors may be easily damaged or reduced in lifetime because of rough work conditions.

### DISCLOSURE

### Technical Problem

Accordingly, the present invention has been made keeping in mind the above problems occurring in the prior art, and an object of the present invention is to provide a tractor having a reinforced buffering function which includes: an upper link and a lower link which are hinged to upper and lower portions of a front axle so as to form a pair of four-bar link structures on the left and right portions of the front axle; buffer cylinders respectively installed on the left and right portions of the front axle to provide a buffering structure for absorbing vertical shock applied to the front axle; a pair of arms respectively installed on left and right portions of a rear axle and configured such that the arms are stationary with respect to the lateral direction and are movable with respect to the vertical direction; and buffer cylinders respectively provided on the left and right portions of the rear axle so as to provide a buffering structure for absorbing vertical shock applied to the rear axle, thereby more effectively absorbing shock applied to the front and rear axles of the tractor when the tractor carries out work or moves.

### Technical Solution

In order to accomplish the above object, in an aspect, the present invention provides a tractor having a reinforced buffering function, including: a body frame; and a front axle and a rear axle respectively coupled to front and rear portions of the body frame, the tractor further including: an upper link and a lower link hinged at first ends thereof to upper and lower portions of each of left and right ends of the front axle, each of the upper and lower links extending a predetermined length in a longitudinal direction of the body frame, while second ends of the upper and lower links are coupled to corresponding portions of the body frame, thus forming a four-bar link structure; and a buffer cylinder provided on each of the left and right ends of the front axle so as to absorb shock applied to the front axle.

The front axle may have a “ [symbol] ” shape so that when the front wheels turned to the left or the right, each of the front wheels enters space defined below the corresponding four-bar link structure.

The four-bar link structure may be configured such that when the tractor carries out work in one place, the supply of compressed gas or hydraulic pressure into the buffer cylinders is interrupted to stop operation of the buffer cylinders.

The tractor may further include: a pair of arms respectively protruding from left and right portions of the rear axle, the pair of arms being hinged to the body frame in such a way that the arms and the rear axle are stationary with respect to a later direction and are movable with respect to a vertical direction; and a buffer cylinder provided on the rear axle so as to absorb shock applied to the rear axle.

The tractor may further include a lateral movement prevention link coupled at a first end thereof to the body frame and coupled at a second end thereof to the front axle, the lateral movement prevention link preventing the front axle from moving in a lateral direction.

In another aspect, the present invention a four-wheel drive tractor having a reinforced buffering function, including: a body frame; and a front axle and a rear axle respectively coupled to front and rear portions of the body frame, the four-wheel drive tractor further including: a pair of arms respectively protruding from left and right portions of the rear axle, the pair of arms being hinged to the body frame in such a way that the arms and the rear axle are stationary with respect to a later direction and are movable with respect to a vertical direction; and a buffer cylinder provided on the rear axle so as to absorb shock applied to the rear axle.

When the tractor carries out work in one place, the supply of compressed gas or hydraulic pressure into the buffer cylinder may be interrupted to stop operation of the buffer cylinder.

The tractor may further include a shock absorber provided at a position at which each of the buffer cylinders is provided, the shock absorber being oriented in a direction parallel to the buffer cylinder.

### Advantageous Effects

In a tractor having a reinforced buffering function according to the present invention, an upper link and a lower link are hinged at first ends thereof to upper and lower portions of each of left and right ends of the front axle, while second ends of the upper and lower links are coupled to corresponding portions of the body frame, thus forming a four-bar link structure. A buffer cylinder is provided on each of the left and right ends of the front axle so as to absorb shock applied to the front axle.

Furthermore, arms respectively protrude from left and right portions of the rear axle and are hinged to the body frame in such a way that the arms and the rear axle are stationary with respect to the later direction and are movable with respect to the vertical direction. A buffer cylinder is provided on the rear axle so as to absorb shock applied to the rear axle. By virtue of this structure, shock applied to the rear axle while the tractor moves or carries out work in one place can be more effectively absorbed.

### DESCRIPTION OF DRAWINGS

FIG. 1 is a perspective view illustrating a tractor having a reinforced buffering function, according to an embodiment of the present invention;

FIG. 2 is a perspective view showing a buffering structure coupled to a body frame of the tractor according to the present invention;

FIG. 3 is a perspective view of the buffering structure when viewed from a rear axle, according to the present invention;

FIG. 4 is a perspective view of the buffering structure when viewed from a front axle, according to the present invention;

FIG. 5 is a plan view of the buffering structure according to the present invention; and

FIG. 6 is a rear view illustrating the buffering structure according to the present invention.

### DESCRIPTION OF THE REFERENCE NUMERALS IN THE DRAWINGS

10: driver cab
21: front wheel
22: rear wheel
30: body frame
40: articulated arm
41: rotating shaft
50: front axle
51: upper link
52: lower link
53: buffer cylinder
54: accumulator
55: shock absorber
56. 65: buffer rubber
57: lateral movement prevention link
60: rear axle
61: arm
62: buffer cylinder
63: accumulator
64: shock absorber
71: transmission
72: central differential device
73: front wheel propulsion shaft
74: rear wheel propulsion shaft
77: PTO shaft

### BEST MODE

Hereinafter, a tractor having a reinforced buffering function according to the present invention will be described in detail with reference to the attached drawings.

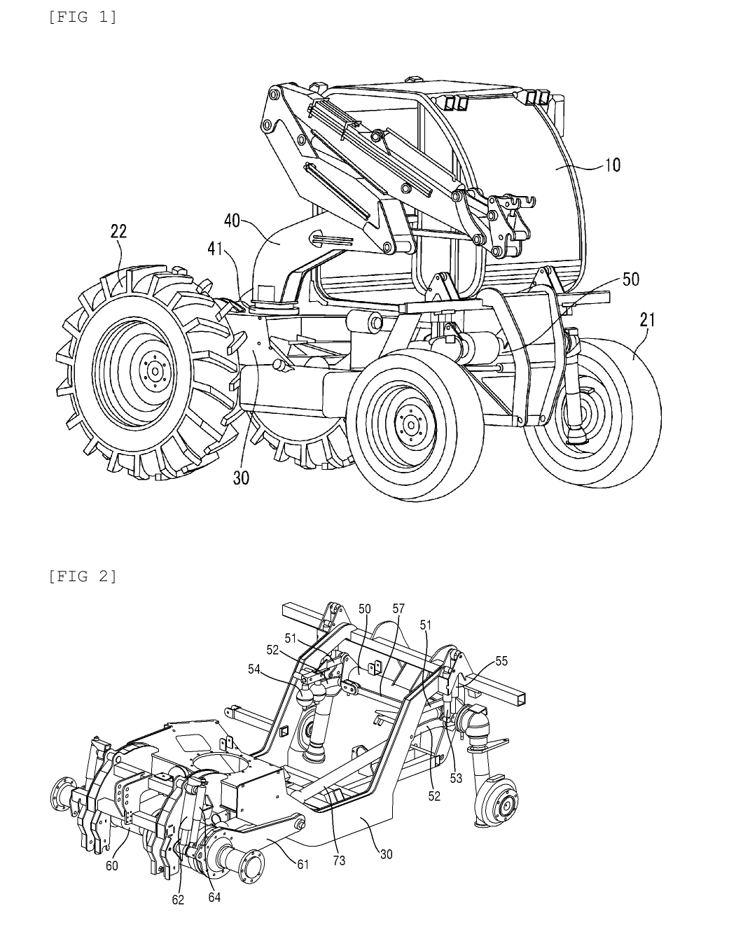

As shown in FIG. 1, in the tractor according to an embodiment of the present invention, a driver cab 10 having a driver seat therein is located on a left side portion of a body frame 30 of the tractor, and an articulated arm 40 is disposed on a portion of the body frame 30 where the driver cab 10 is not located, so as to maintain the balance of the tractor. The articulated arm 40 is coupled to a rotating shaft 41 so that the articulated arm 40 can be rotated along with the rotating shaft 41. In detail, the driver cab 10 is disposed between front wheels 21 and rear wheels 22 of the tractor and located on the left side portion of the tractor such that a space is formed beside the driver cab 10. When the articulated arm 40 is not in use, the articulated arm 40 is maintained in a folded state in this space. The present invention is not limited to the structure of FIG. 1.

A power transmission structure of the tractor according to the present invention will be briefly described below. Rotating power generated from an engine unit (not shown) such as a diesel engine is transmitted to a transmission 71. The power is transmitted from the transmission 71 to a PTO shaft 77 and a central differential device 72 which adjusts drive rpms of the front wheels 21 and rear wheels 22. The central differential device 72 is configured such that power is transmitted both to a front wheel propulsion shaft 73 which operates the front wheels 21 and to a rear wheel propulsion shaft 74 which operates the rear wheels.

The front axle 50 which operates the front wheels 21 disposed in the front of the tractor is disposed at a position higher than the rear axle 60, which operates the rear wheels, so that when the front wheels 21 are completely turned, the front wheels 21 are prevented from being impeded by the front axle 50.

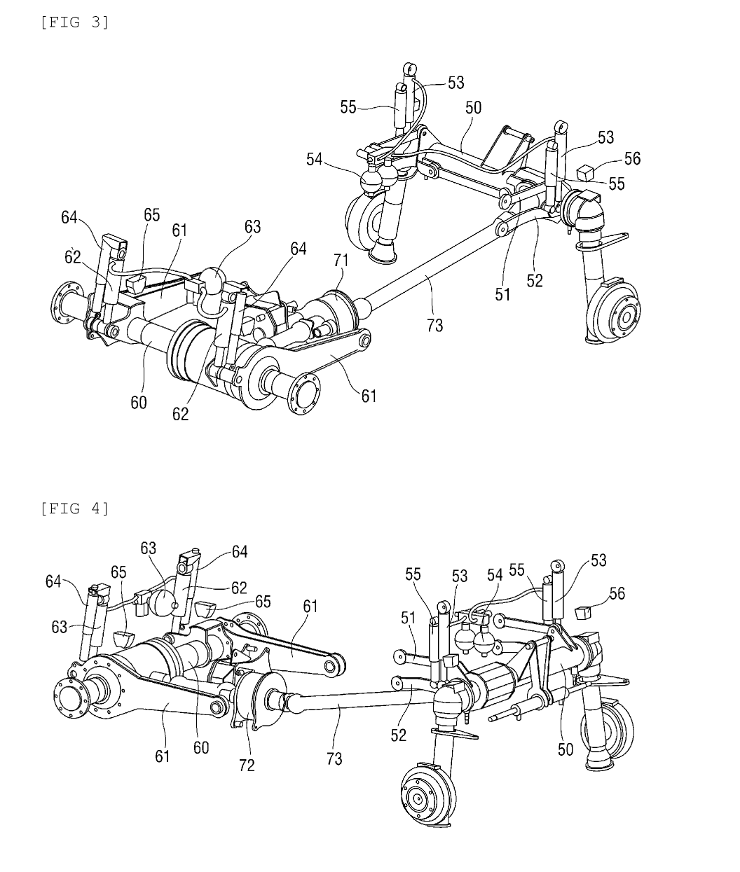

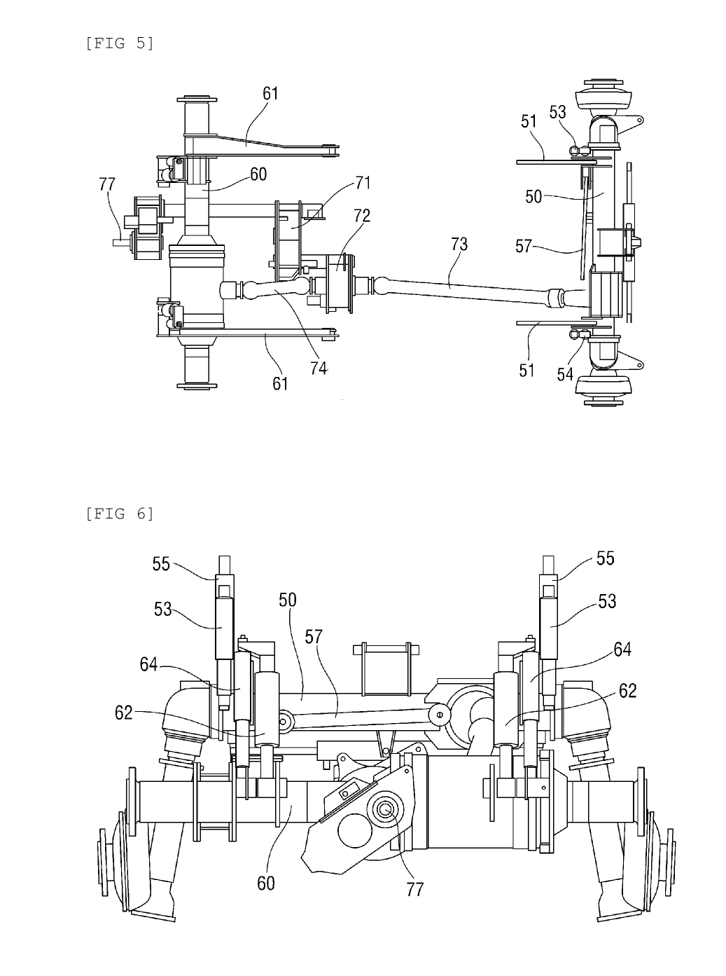

A buffering structure for the front axle 50 will be explained in detail with reference to FIGS. 2 through 6.

An upper link 51 and a lower link 52 are hinged at first ends thereof to upper and lower portions of each of left and right ends of the front axle 50. The upper and lower links 51 and 52 extend predetermined lengths in the longitudinal direction of the body frame. Second ends of the upper and lower links 51 and 52 are coupled to corresponding portions of the body frame, thus forming a four-bar link structure. Thereby, even if external shock is applied to the front axle 50, it can be moved upwards and downwards.

A buffer cylinder 53 is provided adjacent to each of the portions of the front axle 50 to which the upper and lower links 51 and 52 are hinged, whereby when the front axle 50 moves upwards and downwards, it can be prevented from excessively rapidly moving upwards and downwards, thus reducing shock applied to the front axle 50. It is preferable that each buffer cylinder 53 be disposed at a height corresponding to the front axle 50 or higher than that of the front axle 50 such that when the front wheels 21 are completely turned, the front wheels 21 are prevented form being impeded by the buffer cylinder 53.

Each buffer cylinder 53 is connected to an accumulator 54 which is charged with compressed gas. When shock is applied to the front axle 50, the buffer cylinder 53 moves upwards and downwards with expansion and absorption of nitrogen gas, thus absorbing shock applied to the front axle 50.

It is preferable that the gas be nitrogen gas. The reason for this is because of the fact that among compressible gases, nitrogen gas is most affordable, is comparatively inexpensive, and is stable, in other words, is low in reactivity, nonflammable, nontoxic and is not a combustion supporting gas.

Furthermore, to more effectively mitigate shock applied to the front axle 50, a shock absorber 55 may be further provided parallel to each buffer cylinder 53. The shock absorber 55 is filled with a filler such as gas, oil or the like and functions to increase vertical movement damping force of the buffer cylinder 53.

There are cases where the tractor is in motion and the case where the tractor carries out work in one place. When the tractor carries out work in one place, it is preferable that the front axle 50 does not move upwards or downwards. Therefore, in this case, the operation of the accumulators 54 is stopped so that the supply of the compressed gas or hydraulic pressure into the buffer cylinders 53 is interrupted such that the operation of the buffering structure of the front axle 50 is stopped.

To prevent the front axle 50 from moving to the left or the right, a lateral movement prevention link 57 which is hinged at a first end thereof to the body frame 30 and is hinged at a second end thereof to the front axle 50 is further provided. That is, the lateral movement prevention link 57 can prevent the front axle 50 from moving to the left or the right while allowing the front axle 50 to move upwards or downwards.

The front axle 50 has a “ [symbol] ” shape so that when the front wheels 21 is turned to the left or the right, each front wheel 21 can enter space defined below the corresponding four-bar link structure.

In addition, to more effectively absorb shock applied to the front axle 50, the buffering structure for the front axle 50 may further include a rubber buffer 56 which is provided on the front axle 50.

A buffering structure for the rear axle 60 will be explained with reference to FIGS. 2 through 6.

The buffering structure for the rear axle 60 includes a pair of arms 61 which extend predetermined lengths in the longitudinal direction of the tractor and respectively protrude from left and right portions of the rear axle 60. Corresponding ends of the arms 61 are hinged to the body frame 30 so that the arms 61 and the rear axle 60 are stationary with respect to the later direction and are able to move with respect to the vertical direction. By virtue of such structure, when the tractor makes a turn while driving, it can be prevented from rolling over.

Furthermore, a buffer cylinder 62 is provided adjacent to each of the portions of the rear axle 60 to which the arms 61 are installed, whereby when the rear axle 60 moves upwards and downwards, it can be prevented from excessively rapidly moving upwards and downwards, thus reducing shock applied to the rear axle 60. Each buffer cylinder 62 is connected to an accumulator 63 which is charged with compressed gas. Thus, when shock is applied to the rear axle 60, the buffer cylinder 62 moves upwards and downwards with expansion and absorption of the nitrogen gas, thus preventing the rear axle 60 from excessively rapidly moving upwards or downwards.

To more effectively mitigate shock applied to the rear axle 60, a shock absorber 64 may be further provided parallel to each buffer cylinder 62. The shock absorber 64 is filled with a filler such as gas, oil or the like and functions to increase vertical movement damping force of the buffer cylinder 62.

It is preferable that the rear axle 60 does not move upwards or downwards when the tractor carries out work in one place. Therefore, in this case, the operation of the buffering structure of the rear axle 60 must be stopped. For this, the operation of the accumulators 63 is stopped so that the supply of the compressed gas or hydraulic pressure into the buffer cylinders 62 is interrupted.

In addition, to more effectively absorb shock applied to the rear axle 60, the buffering structure for the rear axle 60 may further include a rubber buffer 65 which is provided on the rear axle 60.

As such, the tractor according to the present invention can be configured such that both the buffering structure for the front axle 50 and the buffering structure for the rear axle 60 are used.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A tractor having a reinforced buffering function, having: a body frame; and a front axle and a rear axle respectively coupled to front and rear portions of the body frame, the tractor comprising:
an upper link and a lower link hinged at first ends thereof to upper and lower portions of each of left and right ends of the front axle, each of the upper and lower links extending a predetermined length in a longitudinal direction of the body frame, while second ends of the upper and lower links are coupled to corresponding portions of the body frame, thus forming a four-bar link structure; and
a buffer cylinder provided on each of the left and right ends of the front axle so as to absorb shock applied to the front axle.

2. The tractor according to claim 1, wherein the front axle has a “ [symbol] ” shape so that when the front wheels turned to the left or the right, each of the front wheels enters space defined below the corresponding four-bar link structure.

3. The tractor according to claim 1, wherein the four-bar link structure is configured such that when the tractor carries out work in one place, supply of compressed gas or hydraulic pressure into the buffer cylinders is interrupted to stop operation of the buffer cylinders.

4. The tractor according to claim 1, further comprising:
a pair of arms respectively protruding from left and right portions of the rear axle, the pair of arms being hinged to the body frame in such a way that the arms and the rear axle are stationary with respect to a later direction and are movable with respect to a vertical direction; and
a buffer cylinder provided on the rear axle so as to absorb shock applied to the rear axle.

5. The tractor according to claim 1 further comprising
a lateral movement prevention link coupled at a first end thereof to the body frame and coupled at a second end thereof to the front axle, the lateral movement prevention link preventing the front axle from moving in a lateral direction.

6. A four-wheel drive tractor having a reinforced buffering function, having: a body frame; and a front axle and a rear axle respectively coupled to front and rear portions of the body frame, the four-wheel drive tractor comprising:
a pair of arms respectively protruding from left and right portions of the rear axle, the pair of arms being hinged to the body frame in such a way that the arms and the rear axle are stationary with respect to a later direction and are movable with respect to a vertical direction; and
a buffer cylinder provided on the rear axle so as to absorb shock applied to the rear axle.

7. The tractor according to claim 6, wherein when the tractor carries out work in one place, supply of compressed gas or hydraulic pressure into the buffer cylinder is interrupted to stop operation of the buffer cylinder.

8. The tractor according to claim 6, further comprising
a shock absorber provided at a position at which each of the buffer cylinders is provided, the shock absorber being oriented in a direction parallel to the buffer cylinder.

9. The tractor according to claim 4, wherein when the tractor carries out work in one place, supply of compressed gas or hydraulic pressure into the buffer cylinder is interrupted to stop operation of the buffer cylinder.

10. The tractor according to claim 1, further comprising
a shock absorber provided at a position at which each of the buffer cylinders is provided, the shock absorber being oriented in a direction parallel to the buffer cylinder.

11. The tractor according to claim 2, further comprising
a lateral movement prevention link coupled at a first end thereof to the body frame and coupled at a second end thereof to the front axle, the lateral movement prevention link preventing the front axle from moving in a lateral direction.

12. The tractor according to claim 3, further comprising
a lateral movement prevention link coupled at a first end thereof to the body frame and coupled at a second end thereof to the front axle, the lateral movement prevention link preventing the front axle from moving in a lateral direction.

13. The tractor according to claim 4, further comprising
a lateral movement prevention link coupled at a first end thereof to the body frame and coupled at a second end thereof to the front axle, the lateral movement prevention link preventing the front axle from moving in a lateral direction.
